(19) United States
(12) Patent Application Publication
(10) Pub. No.: US 2023/0238857 A1
(43) Pub. Date: Jul. 27, 2023

(54) MAGNETIC LEVITATION SYSTEM

(71) Applicants: SHENZHEN INSTITUTES OF ADVANCED TECHNOLOGY CHINESE ACADEMY OF SCIENCES, Shenzhen, Guangdong (CN); NATIONAL INSTITUTE OF ADVANCED MEDICAL DEVICES, SHENZHEN, Shenzhen, Guangdong (CN)

(72) Inventors: Tianfu SUN, Shenzhen, Guangdong (CN); Hairong ZHENG, Shenzhen, Guangdong (CN); Jianing LIANG, Shenzhen, Guangdong (CN); Linghui LONG, Shenzhen, Guangdong (CN); Fucheng JIANG, Shenzhen, Guangdong (CN); Huiyun LI, Shenzhen, Guangdong (CN); Liwen WAN, Shenzhen, Guangdong (CN); Long LI, Shenzhen, Guangdong (CN)

(73) Assignees: SHENZHEN INSTITUTES OF ADVANCED TECHNOLOGY CHINESE ACADEMY OF SCIENCES, Shenzhen, Guangdong (CN); NATIONAL INSTITUTE OF ADVANCED MEDICAL DEVICES, SHENZHEN, Shenzhen, Guangdong (CN)

(21) Appl. No.: 17/611,808

(22) PCT Filed: Mar. 23, 2021
(86) PCT No.: PCT/CN2021/082404

§ 371 Date: Nov. 16, 2021

(51) Int. Cl. H02K 7/09; H02K 1/17; H02K 1/14; H02K 11/21; H02K 11/33

(52) U.S. Cl. CPC H02K 7/09; H02K 1/17; H02K 1/148; H02K 11/21; H02K 11/33

(57) ABSTRACT

The present application disclosed a magnetic levitation system, and the magnetic levitation system includes a stator, a rotor, and a magnetic coupling mechanism; the stator includes a stator winding mechanism for controlling the rotor to move away from or close to the axis direction of the stator. The magnetic coupling mechanism includes magnetic sources, and the magnetic coupling mechanism is magnetically coupled with the rotor through the magnetic sources to drive the rotor to rotate around the axis direction of the stator. The magnetic levitation system decouples the magnetic circuit that drives the rotor to move from the magnetic circuit that drives the rotor to rotate, so as to reduce control difficulty, enhance stability, and reduce torque fluctuations.

### TECHNICAL FIELD

The present application relates to the technical field of magnetic levitation devices, and more particularly to a magnetic levitation system.

### BACKGROUND

A magnetic levitation motor is a motor with a non-contact operation between the stator and the rotor. In the magnetic levitation motor, a magnetic drive mechanism is arranged on the stator, and the magnetic drive mechanism is used to drive the rotor to levitate on the one hand, and to drive the rotor to rotate on the other hand. However, this design makes the magnetic circuit that drives the electronic levitation highly coupled with the magnetic circuit that drives the rotor to rotate, which increases the difficulty of control, and leads to poor motor stability and large torque fluctuations.

### TECHNICAL PROBLEM

One of the objects of embodiments of the present application provides a magnetic levitation system, which aimed to solve the technical problem that the magnetic circuit of the magnetic levitation bearing and the magnetic circuit of the motor are highly coupled in the prior art of the magnetic levitation motor, which increases the difficulty of control, and leads to poor motor stability and large torque fluctuations.

### SUMMARY

In order to solve above-mentioned technical problem, the technical solution adopted by embodiments of the present application is that:

In a first aspect, a magnetic levitation system is provided, and the magnetic levitation system includes:

a stator, including stator cores, stator permanent magnets, and a stator winding mechanism, wherein each stator permanent magnet and the stator winding mechanism are both arranged at the stator core;

a rotor, providing with a magnetically permeable material structure, wherein the stator winding mechanism is configured for controlling the rotor to move away from or close to an axis direction of the stator;

a magnetic coupling mechanism, including magnetic sources capable of being magnetically attracted to the magnetically permeable material structure, wherein the magnetic coupling mechanism is configured for magnetically coupling with the rotor to drive the rotor to rotate around the axis direction of the stator.

In an embodiment, a number of the magnetic sources is multiple, and the multiple magnetic sources are distributed at intervals along a circular track on a plane perpendicular to the axial direction of the stator; polarities of the magnetic sources are the same, or polarities of two adjacent magnetic sources are opposite.

In an embodiment, the stator is further provided with secondary windings, and a magnetic field direction generated by each of the secondary windings is the same as or opposite to a magnetic field direction generated by each of the stator permanent magnets.

In an embodiment, the magnetic levitation system further includes a connecting frame, the magnetically permeable material structure is arranged onto the rotor through the connecting frame, and the connecting frame is located between the magnetic coupling mechanism and the rotor.

In an embodiment, the magnetic levitation system further includes a first position sensor, and the first position sensor is configured for detecting a position of the rotor on a planer perpendicular to the axial direction of the stator, the first position sensor includes a stator portion and a rotor portion, the stator portion is connected to the stator, the rotor portion is connected to the rotor, and the stator portion and the rotor portion are arranged coaxially.

In an embodiment, at least part of a structure of the rotor portion is made of a magnetically permeable material, or

the magnetic coupling mechanism is provided with a rotor permanent magnet.

In an embodiment, each of the stator cores is provided with an arc-shaped stator yoke and stator teeth extending in a direction close to the rotor, and the stator winding mechanism is arranged at the stator yoke and/or the stator teeth;

the magnetic levitation system further includes a second position sensor mounted on the stator teeth or between two adjacent stator teeth.

In an embodiment, a number of the stator winding mechanism is at least two, and each stator winding mechanism includes first stator windings and second stator windings, and the first stator windings and the second stator windings are arranged symmetrically with respect to the axis of the stator.

In an embodiment, the magnetic levitation system further includes a winding drive mechanism including a full-bridge circuit; in the stator winding mechanism, the first stator windings and the second stator windings are respectively connected to corresponding full-bridge circuit, and dotted terminals of the first stator windings are connected to dotted terminals of the second stator windings.

In an embodiment, in the stator winding mechanism, a number of the first stator winding is multiple, and the multiple first stator windings are connected in series;

and/or, a number of the second stator winding is multiple, and the multiple second stator winding are connected in series.

### BENEFICIAL EFFECT

The beneficial effect of the magnetic levitation system provided by the embodiments of the present application is that: compared with the prior art, the magnetic levitation system of the present application can be applied to a magnetic levitation motor. The stator winding mechanism on the stator adjusts the rotor to move away from or close to the axis direction of the stator, that is, the position of the rotor on the plane perpendicular to the axis direction of the stator can be adjusted, and the position of the rotor in the axis direction of the stator can be controlled by the stator permanent magnet on the stator and the magnetic coupling mechanism, so that the rotor can reach a levitated state; the magnetic coupling mechanism drives the rotor to rotate around the axis direction of the stator. With this arrangement, the magnetic circuit that controls the position and levitation state of the rotor is decoupled from the magnetic circuit that controls the rotation of the rotor, so that the magnetic levitation motor using the magnetic levitation system provided by the present application reduces the difficulty of controlling the magnetic circuit, the operational stability is enhanced and the torque fluctuations are reduced.

### BRIEF DESCRIPTION OF THE DRAWINGS

In order to explain the embodiments of the present application more clearly, a brief introduction regarding the accompanying drawings that need to be used for describing the embodiments of the present application or the prior art is given below; it is obvious that the accompanying drawings described as follows are only some embodiments of the present application, for those skilled in the art, other drawings can also be obtained according to the current drawings on the premise of paying no creative labor.

FIG. 1 is a schematic view of a structure of a magnetic levitation system provided by an embodiment of the present application;

FIG. 2 is an exploded schematic view of parts of a magnetic levitation system provided by an embodiment of the present application;

FIG. 3 is a schematic view of a relative position of a stator and a rotor in a magnetic levitation system provided by an embodiment of the present application;

FIG. 4 is a schematic view of a mounting position of stator permanent magnets in a magnetic levitation system provided by an embodiment of the present application;

FIG. 5 is a schematic view of another mounting position of stator permanent magnets in a magnetic levitation system provided by an embodiment of the present application;

FIG. 6 is a cross-sectional view of a magnetic levitation system in FIG. 3;

FIG. 7 is a schematic view of a mounting position of a stator portion of a first position sensor in to magnetic levitation system provided by an embodiment of the present application;

FIG. 8 is a schematic view of another mounting position of a stator portion of a first position sensor in a magnetic levitation system provided by an embodiment of the present application;

FIG. 9 is a circuit control diagram of a stator winding mechanism in a magnetic levitation system provided by an embodiment of the present application;

FIG. 10 is a schematic view of another arranging manner of a stator winding mechanism in the magnetic levitation system provided by tan embodiment of the present application;

FIG. 11 is a schematic view of an arranging manner of magnetic sources of a magnetic levitation system provided by an embodiment of the present application;

FIG. 12 is a schematic view of another arranging manner of magnetic sources of a magnetic levitation system provided by an embodiment of the present application;

FIG. 13 is a first cross-sectional view of a magnetic levitation system provided with another rotor structure in an embodiment of the present application;

FIG. 14 is a second cross-sectional view of a magnetic levitation system provided with another rotor structure in an embodiment of the present application;

FIG. 15 is a schematic view of another structure of a magnetic levitation system provided by an embodiment of the present application;

FIG. 16 is a schematic view of further structure of a magnetic levitation system provided by an embodiment of the present application;

FIG. 17 is a cross-sectional view of FIG. 16;

FIG. 18 is a schematic view of an arrangement of secondary windings of a magnetic levitation system provided by an embodiment of the present application.

The details of the labels involved in the above drawings are as follows:

1—stator; 2—rotor; 3—magnetic coupling mechanism; 4—first position sensor; 5—second position sensor; 6—air gap;

11—stator core; 12—stator permanent magnet; 13—first stator winding; 14—second stator winding; 15—stator pillar; 16—secondary winding;

21—magnetically permeable material structure; 22—connecting frame;

31—magnetic source; 32—support plate; 33—central shaft;

41—stator portion; 42—rotor portion;

71—first electronic circuit switch tube; 72—second electronic circuit switch tube; 73—third electronic circuit switch tube; 74—fourth electronic circuit switch tube; 75—fifth electronic circuit switch tube; 76—sixth electronic circuit switch tube; 77—seventh electronic circuit switch tube; 78—eighth electronic circuit switch tube;

81—current controller; 82—current sensor; 83—bus; 84—ground wire;

111—stator yoke; 112—stator tooth; 131-A first stator winding; 132-B first stator winding; 141-A second stator winding; 142-B second stator winding; 221—connecting post; 222—mounting plate.

### DETAILED DESCRIPTION

In order to make the objects, technical solutions, and advantages of the present application clearer, the following further describes the present application in detail with reference to the accompanying drawings and embodiments. It should be understood that the specific embodiments described here are only used to explain the present application, and are not used to limit the present application.

It should be noted that when an element is referred to as being “fixed to” or “disposed on” another element, it can be directly on the other element or indirectly on the other element. When an element is referred to be “connected to” another element, it can be directly connected to the other element or indirectly connected to the other element.

It should be understood that the directions or positional relationships indicated by the terms “upper”, “lower”, “front”, “rear”, “left”, “right”, “inner”, “outer”, etc. are based on the drawings. The orientation or positional relationship of is only for the convenience of describing the present application and simplifying the description, rather than indicating or implying that the device or element referred to must have a specific orientation, be constructed and operated in a specific orientation, and therefore cannot be construed as a limitation of the present application.

In addition, the terms “first” and “second” are only used for descriptive purposes, and cannot be understood as indicating or implying relative importance or implicitly indicating the number of indicated technical features. Thus, the features defined with “first” and “second” may explicitly or implicitly include one or more of these features. In the description of the present application, “multiple” means two or more than two, unless otherwise specifically defined.

In order to illustrate the technical solutions described in the present application, the detailed description will be given below in conjunction with specific drawings and embodiments.

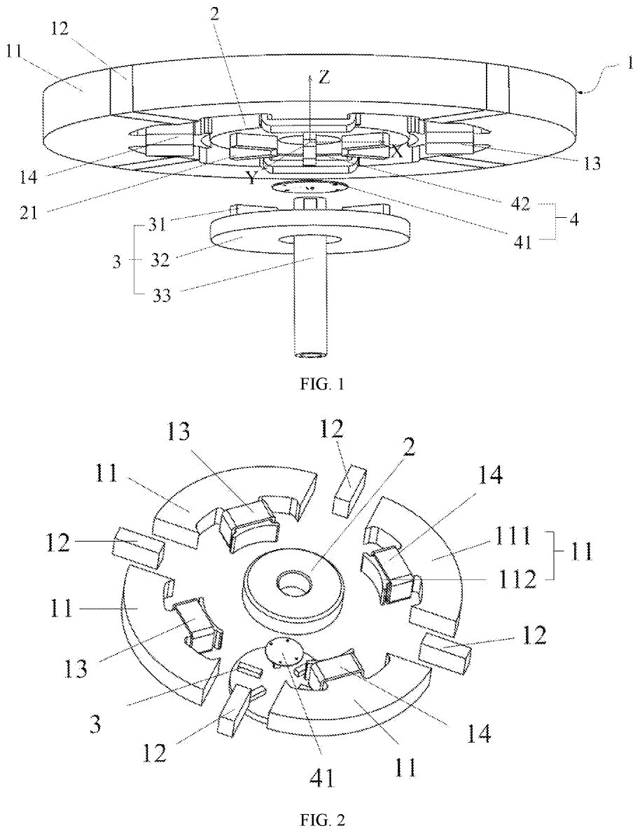

As shown in FIGS. 1 and 2, embodiments of the present application provide a magnetic levitation system, which includes: a stator 1, a rotor 2, and a magnetic coupling mechanism 3. The stator 1 includes stator cores 11, stator permanent magnets 12, and a stator winding mechanism. The stator permanent magnet 12 and the stator winding mechanism are both arranged on the stator core 11.

There is an air gap 6 between the rotor 2 and the stator 1. In a specific embodiment, the stator 1 has a ring-shaped structure, and the rotor 2 is located in the inner ring area of the stator 1. In another specific embodiment, the rotor 2 has a ring-shaped structure, and the stator 1 is located in the inner ring area of the rotor 2. There is a certain gap between the magnetic coupling mechanism 3 and the axial end surface of the rotor 2. The rotor 2 is provided with a magnetically permeable material structure 21. The magnetic coupling mechanism 3 includes magnetic sources 31, and the magnetic field generated by the magnetic sources 31 can magnetically attract the magnetically permeable material structure 21, so that the magnetic coupling mechanism 3 can be magnetically coupled with the rotor 2 and drive the rotor 2 to rotate around the axis direction of the stator 1.

The stator winding mechanism is used to control the position of the rotor 2 on a plane perpendicular to the axial direction of the stator 1 so that the rotor 2 is coaxial with the stator 1.

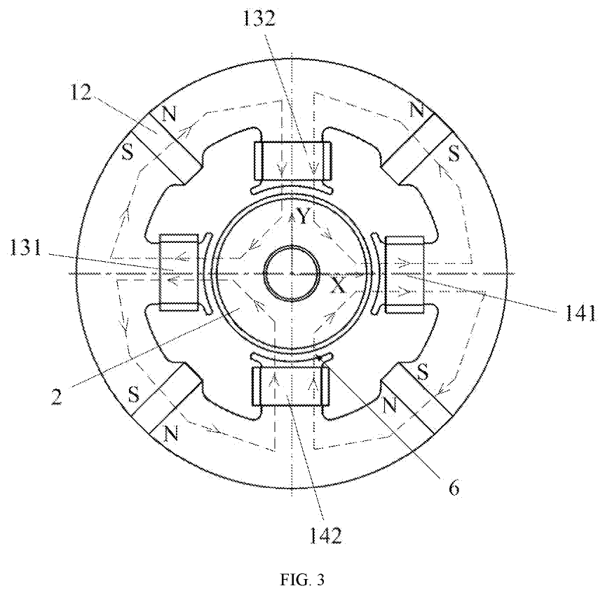

As shown in FIG. 1 and FIG. 3, the line along the axis of the stator is the Z axis, and the X axis and Y axis perpendicular to each other are set on a plane perpendicular to the Z axis to form a spatial coordinate system; the plane where the X axis and the Y axis located is called the X-Y plane. Taking the position of the rotor 2 as a reference, the direction of the magnetic coupling mechanism 3 relative to the rotor 2 in FIG. 1 is referred to as the negative direction of the Z axis, and the reverse direction is referred to as the positive direction of the Z axis. The stator winding mechanism is configured to control the position of the rotor 2 in the X-Y plane, and the magnetic coupling mechanism 3 is configured to control the rotation of the rotor 2 around the Z axis. Since the stator 1 is provided with the stator permanent magnet 12, and the stator permanent magnet 12 causes the rotor 2 to be applied with an upward force, which has a component force on the Z axis toward the positive direction of the Z axis, and the magnetic sources 31 on the magnetic coupling mechanism 3 apply an attractive force on the Z-axis toward the negative direction of the Z-axis to the rotor 2, which offsets the component force of the permanent magnet applied to the rotor 2 in the positive direction of the Z-axis, so that the rotor 2 can levitate on the Z-axis in the set position.

In a specific implementation of the embodiment, the stator core 11 has a stator yoke 111 and stator teeth 112. The stator yoke 111 has an arc structure, and the stator teeth 112 are connected to the stator yoke 111, or the stator teeth 112 and the stator yoke 111 is an integrated structure, the stator teeth 112 extend from the stator yoke 111 in a direction close to the rotor 2. Specifically, when the rotor 2 is arranged inside the stator 1, the stator teeth 112 extend from the stator yoke 111 in a direction close to the axis of the stator 1; when the rotor 2 is arranged outside the stator 1, the stator teeth 112 extend from the stator yoke 111 in a direction away from the axis direction of the stator 1.

Each stator permanent magnet 12 is arranged between two adjacent stator cores 11. Preferably, the number of stator cores 11 is an even number, and the number of stator permanent magnets 12 is an even number. Preferably, as shown in FIGS. 3 and 5, the stator permanent magnets 12 are arranged opposite to each other, and the polarities (S poles or N poles) of two adjacent stator permanent magnets 12 are arranged opposite to each other.

As shown in FIGS. 1 to 3, the stator core 11 is clamped between two adjacent stator permanent magnets 12.

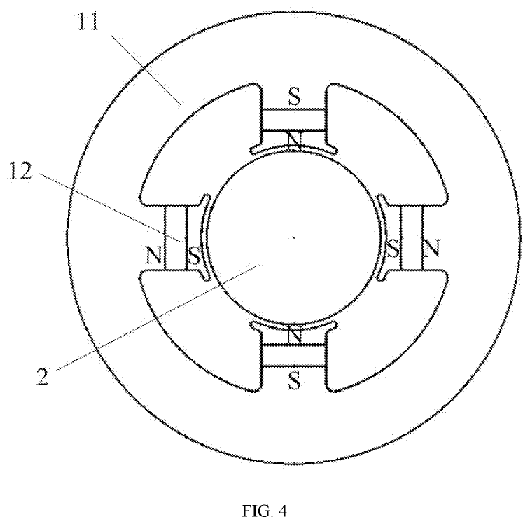

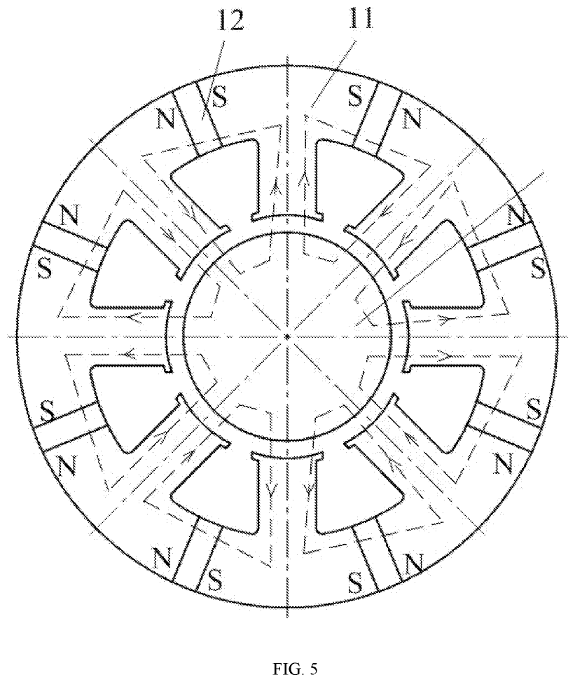

Alternatively, as shown in FIG. 4, in another specific embodiment, the stator permanent magnets 12 may also be arranged on the stator teeth 112. In this arrangement, the polarities of the opposite stator permanent magnets 12 are arranged opposite to each other.

In the magnetic levitation system provided by the embodiment, the number of stator winding mechanisms is at least two. The stator winding mechanism includes first stator windings 13 and second stator windings 14, and the first stator windings 13 and the second stator windings 14 are arranged symmetrically relative to the axis of the stator 1. The number of first stator windings 13 is the same as the number of second stator windings 14. Each of the first stator windings 13 can be sleeved on the stator yoke 111 or the stator teeth 112; correspondingly, each of the second stator windings 14 can be sleeved on the stator yoke 111 or the stator teeth 112.

For example, in the magnetic levitation system shown in FIGS. 1 to 3, the number of stator winding mechanisms is two. In the direction shown in FIG. 3, the first stator winding 13 and the second stator windings 14 in one of the stator winding mechanisms are arranged at intervals along the X axis, and the first stator winding 13 and the second stator winding 14 in another of the stator winding mechanisms are arranged at intervals along the Y axis. The position of the rotor 2 in the X axis direction can be adjusted through the arrangement of the first stator winding 13 and the second stator winding 14 along the X axis direction, and the position of the rotor 2 in the Y axis direction can be adjusted through the arrangement of the first stator winding 13 and the second stator winding 14 along the Y axis direction.

If the connection between the first stator winding 13 and the second stator winding 14 in the same stator winding mechanism is called a connecting wire, when the number of stator winding mechanisms in the stator 1 is multiple, the crossing points of the multiple connecting wires are located on the axis of the stator 1. Preferably, the angles of the included angles between adjacent connecting lines are the same.

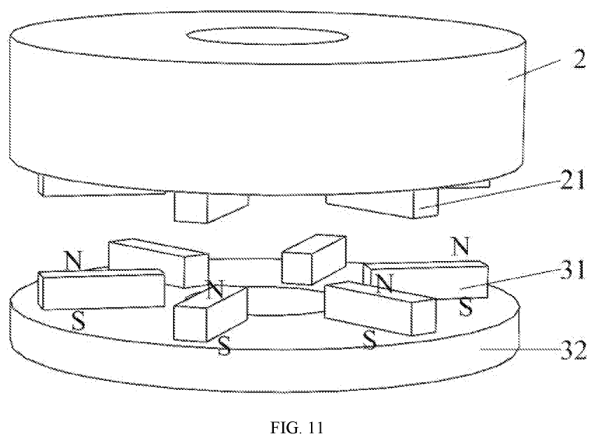

In one stator winding mechanism, the number of first stator windings 13 can be one or more, the number of second stator windings 14 can be one or more, and the number of first stator windings 13 is the same as that of second stator windings 14, and each of the first stator windings 13 and each of the second stator windings 14 are arranged in one-to-one correspondence. For example, in FIG. 10, two stator winding mechanisms are provided, and in the direction shown in FIG. 10, the first stator winding 13 on the upper stator core 11 and the second stator winding 14 on the lower stator core 11 belongs to the same stator winding mechanism, and the remaining first stator winding 13 and the second stator winding 14 belong to another stator winding mechanism. Each stator winding mechanism includes three first stator windings 13 and three second stator windings 14.

In the following, the number of stator winding mechanisms is two, and each stator winding mechanism includes one first stator winding 13 and one second stator winding 14 as an example to describe the adjustment process of the position of the rotor 2 in the XY plane. For ease of description, one of the stator winding mechanisms is called an A stator winding mechanism, and another is called a B stator winding mechanism. As shown in FIG. 3, the first stator winding 13 included in the A stator winding mechanism is called A first stator winding 131, and the second stator winding 14 is referred to as an A second stator winding 141; the first stator winding 13 included in the B stator winding mechanism is referred to as a B first stator winding 132; and the second stator winding 14 is referred to as a B second stator winding 142. The A first stator winding 131 is located in the negative direction of the X axis, the A second stator winding 141 is located in the positive direction of the X axis, the B first stator winding 132 is located in the positive direction of the Y axis, and the B second stator winding 142 is located in the negative direction of the Y axis. The stator 1 includes four stator cores 11 and four stator permanent magnets 12. One stator permanent magnet 12 is arranged between every two adjacent stator cores 11, and the polarities of every two adjacent stator permanent magnets 12 are placed opposite each other. In FIG. 2, the S pole of the stator permanent magnet 12 on the upper left side is opposite to the S pole of the stator permanent magnet 12 on the lower left side, and the N pole of the stator permanent magnet 12 on the upper left side is opposite to the N pole of the stator permanent magnet 12 on the upper right side; the N pole of the stator permanent magnet 12 on the lower right side is opposite to the N pole of the stator permanent magnet 12 on the lower left side, and the S pole of the stator permanent magnet 12 on the lower right side is opposite to the S pole of the stator permanent magnet 12 on the upper right side. The magnetic circuit of the magnetic field in the stator cores 11 and the rotor 2 is shown in FIG. 3. If the magnetic density of the air gaps 6 of the four directions of the positive direction of the X axis, the negative direction of the X axis, the positive direction of the Y axis and the negative direction of the Y axis of the rotor 2 with the corresponding stator cores 11 are the same, then the rotor is suffered a balance force, and is stationary at the set position in the X-Y plane.

If a forward current is applied to the A first stator winding 131 (the magnetic field generated by the energized A first stator winding 131 is the same as the magnetic circuit magnetic field generated by the stator permanent magnet 12), then the magnetic density of the air gap 6 close to the A first stator winding 131 will be strengthened. At the same time, if a reverse current is applied to the A second stator winding 141 (the magnetic field generated by the energized A second stator winding 141 is opposite to the magnetic field of the stator permanent magnet 12), the magnetic density of the air gap 6 close to the second stator winding 141 will be weakened. This causes the magnetic density of the air gap 6 close to the A first stator winding 131 of the rotor 2 to be different from the magnetic density of the air gap 6 close to the second stator winding 141 of the rotor 2, which will cause the rotor 2 to suffer from magnetic attraction from the stronger magnetic density of the air gap 6 side, that is, the resultant force suffered by the rotor 2 points to the side that the magnetic density of the air gap 6 is stronger (the negative direction of the X axis), the stronger magnetic side of the air gap 6 (the negative direction of the X axis), so that the rotor 2 moves to the side that the magnetic density of the air gap 6 is stronger, even if the rotor 2 has a tendency to move in the negative direction of the X axis.

In the same way, if a reverse current is applied to the A first stator winding 131 and a forward current is applied to the A second stator winding 141 at the same time, the force suffered by the rotor is directed toward the positive direction of the X axis, which means that the rotor 2 has a tendency to move in the positive direction of the X axis.

In the same way, if a forward current is applied to the B first stator winding 132, and a reverse current is applied to the B second stator winding 142 at the same time, the force suffered by rotor is directed toward the positive direction of the Y axis, which means that the rotor 2 has a tendency to move in the positive direction of the Y axis.

In the same way, if a reverse current is applied to the B first stator winding 132, and a forward current is applied to the B second stator winding 142 at the same time, the force suffered by rotor is directed toward the negative direction of the Y axis, which means that the rotor 2 has a tendency to move in the negative direction of the Y axis.

In this way, by controlling the direction of the current in the first stator windings 13 and the second stator windings 14 in the two stator winding mechanisms, the movement and position controlling of the rotor 2 in the X-Y plane can be achieved.

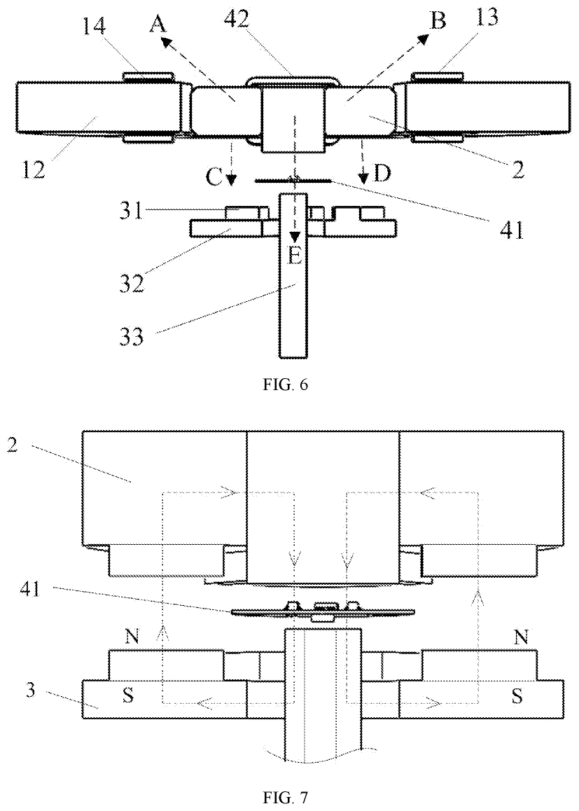

As shown in FIG. 6, due to the presence of stator permanent magnets 12 in the magnetic circuit of the stator 1, there is always a magnetic field in the air gap 6 and a magnetic force is generated on the rotor 2. The rotor 2 is affected by the above-mentioned magnetic force and produces the rotor force A and the rotor force B as shown in FIG. 6. The rotor force A and the rotor force B respectively include a component parallel to the X-Y plane and a component along the positive direction of the Z axis. The component parallel to the X-Y plane is used to control the position of the rotor 2 in the X-Y plane. Since the magnetic coupling mechanism 3 generates a magnetic attraction force on the rotor 2 in the negative direction of the Z axis, the rotor 2 is subjected to the magnetic attraction force of the magnetic coupling mechanism 3 to generate a rotor force C and a rotor force D in the negative direction of the Z axis. In a feasible embodiment, the absolute value of the resultant force of the rotor force C and the rotor force D can be made equal to the absolute value of the resultant force of the components of the rotor force A and the rotor force B along the positive direction of the Z axis, that is, the force of the rotor 2 in the positive direction of the Z-axis is offset with the force of the rotor 2 in the negative direction of the Z-axis, so that the rotor 2 is passively levitated in the direction of the Z-axis.

Alternatively, in a preferred embodiment, the magnetic levitation system includes a first position sensor 4, the first position sensor 4 includes a stator portion 41 and a rotor portion 42, the stator portion 41 is connected to the stator 1, and the rotor portion 42 is connected to the rotor 2. When the rotor 2 moves in a radial direction, the rotor portion 42 moves together with the rotor 2, that is, the rotor portion 42 is displaced relative to the stator portion 41 in the X-Y plane, so that the stator portion 41 and the rotor portion 42 can be used for detection of position information of the rotor 2 on the X-Y plane.

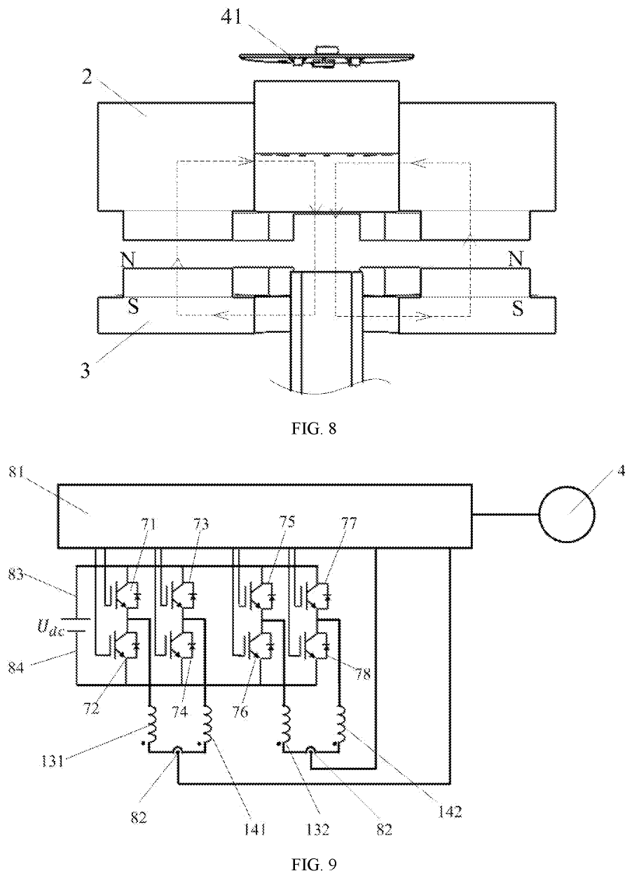

In a possible implementation, the first position sensor 4 includes but is not limited to a magnetic sensor (for example, a Hall sensor), an electric field sensor, a photoelectric sensor, and the like. Preferably, the rotor portion 42 is mounted at the end of the rotor 2 away from the magnetic coupling mechanism 3, and the stator portion 41 can be mounted at the area between the rotor 2 and the magnetic coupling mechanism 3 (as shown in FIG. 7), or it can be mounted at one side of the rotor 2 away from the magnetic coupling mechanism 3 (as shown in FIG. 8). Preferably, both the rotor portion 42 and the stator portion 41 are arranged coaxially with the rotor 2.

When the first position sensor 4 is a magnetic sensor (for example, a Hall sensor), at least part of the structure of the rotor portion 42 is made of magnetically permeable material, that is, only part of the structure of the rotor portion 42 may be made of magnetically permeable material. Alternatively, the entire structure of the rotor portion 42 may be made of a magnetically permeable material. For example, the rotor portion 42 may be a permanent magnet, and the permanent magnet generates a magnetic attraction force on the magnetic coupling mechanism 3, that is, the rotor 2 has another rotor force E in the negative direction of the Z axis.

When the rotor portion 42 is a structure made of non-magnetically permeable material, the rotor permanent magnets can be arranged on the magnetic coupling mechanism 3. The rotor permanent magnets apply a magnetic attraction force in the negative direction of the Z axis to the rotor 2, so that the rotor 2 has the rotor force E in the negative direction of the Z axis (please refer to FIG. 6 for the rotor force E).

As shown in FIG. 6, when the rotor 2 has a rotor force E, the absolute value of the resultant force of the rotor force E, the rotor force C, and the rotor force D is equal to the absolute value of the resultant force of the components of the rotor force A and the rotor force B along the positive direction of the Z axis, that is, the rotor 2 is passively levitated. Due to the above magnetic limitation, the rotor 2 only has three degrees of freedom of rotation around the Z axis and movement along the X-Y plane.

Therefore, by adjusting the currents of the first stator winding 13 and the second stator winding 14 in the stator winding mechanism, the rotor force A and the rotor force B can be adjusted, thereby controlling the position of the rotor 2 in the X-Y plane, so that the rotor 2 is levitated in the set position.

In the magnetic levitation system, which further includes a winding drive mechanism, the winding drive mechanism includes a full-bridge circuit. The number of the full-bridge circuit and the stator winding mechanism is the same, and one full-bridge circuit is used to correspondingly control one stator winding mechanism. In the stator winding mechanism, the first stator winding 13 and the second stator winding 14 are respectively connected to the corresponding full-bridge circuits, and the dotted terminal of the first stator winding 13 and the dotted terminal of the second stator winding 14 are connected.

It is worth noting that when the number of first stator windings 13 is multiple, the multiple first stator windings 13 are connected in series and then connected to the full-bridge circuit. When the number of the second stator windings 14 is multiple, the multiple second stator windings 14 are connected in series and connected to the full-bridge circuit.

Further, the full-bridge single circuit is connected to the current controller 81, the current controller 81 is connected to the first position sensor 4, the current controller 81 is also connected to the current sensor 82, and the current sensor 82 is connected to the connection line between the first stator winding 13 and the second stator winding 14 in the stator winding mechanism.

Hereinafter, taking the number of stator winding mechanisms as two as an example, the current control of the stator winding mechanism of the structure in FIG. 3 will be explained:

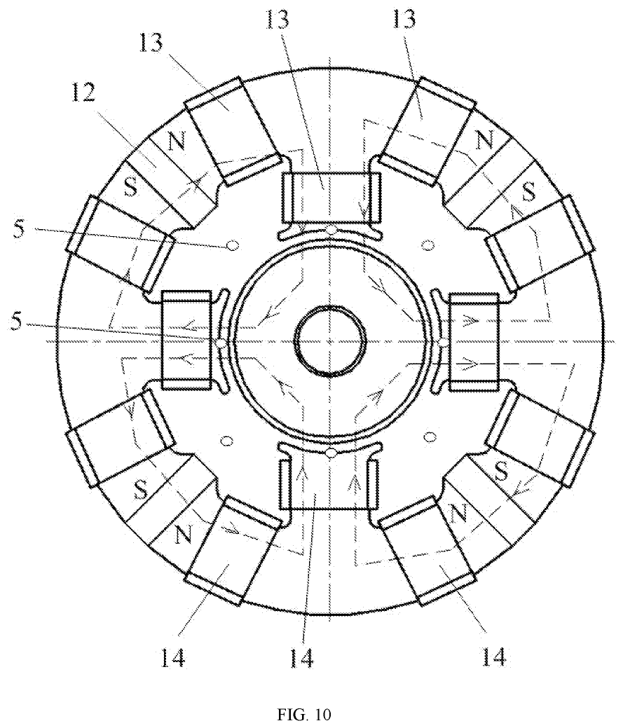

As shown in FIG. 9, the two stator winding mechanisms are provided with two full-bridge circuits corresponding to each other. Among them, the full-bridge circuit connected to the A first stator winding mechanism includes four power electronic switching tubes, which are respectively the first power electronic switching tube 71, the second power electronic switching tube 72, the third power electronic switching tube 73, and the fourth power electronic switching tube 74, the four power electronic switching tubes are respectively connected to the bus 83, the ground wire 84, and the current controller 81. The first power electronic switch tube 71 is connected in series with the second power electronic switch tube 72 and connected to the A first stator winding 131. The third power electronic switch tube 73 is connected in series with the fourth power electronic switch tube 74 and connected to the A second stator winding 141. The full-bridge circuit connected to the B second stator winding mechanism includes four power electronic switching tubes, which are respectively the fifth power electronic switching tube 75, the sixth power electronic switching tube 76, the seventh power electronic switching tube 77, and the eighth power electronic switching tube 78, the four power electronic switch tubes are respectively connected to the bus 83, the ground 84, and the current controller 81. The fifth power electronic switch tube 75 is connected in series with the sixth power electronic switch tube 76 and connected to the B second stator winding 132. The seventh power electronic switch tube 77 is connected in series with the eighth power electronic switch tube 78 and connected to the B second stator winding 142.

The dotted terminal of the A first stator winding 131 is connected to the dotted terminal of the A second stator winding 141, that is, the two are reversely connected to form a pair of windings. Similarly, the dotted terminal of the B first stator winding 132 is connected to the dotted terminal of the B second stator winding 142, that is, the two are reversely connected to form a pair of windings. The full-bridge circuit connected to the A first stator winding mechanism is used to control the position of the rotor 2 in the X axis direction, and the full-bridge circuit connected to the second stator winding mechanism is used to control the position of the rotor 2 in the Y axis direction.

When the first power electronic switch tube 71 and the fourth power electronic switch tube 74 are turned on, and the second power electronic switch tube 72 and the third power electronic switch tube 73 are turned off, the current flows through the DC bus 83 through the first power electronic switch tube into the A first stator winding 131, flows through the A second stator winding 141, and flows into the ground wire 84 through the fourth power electronic switch tube, at this time, the direction of force on the rotor is the negative direction of the X-axis. Pulse width modulation (PWM) technology can be used to control the on-time duty cycle of the first power electronic switch tube 71 and the fourth power electronic switch tube 74, so that the equivalent voltage applied to two ends of the A stator winding mechanism is controlled, and then the current in the corresponding A stator winding mechanism is controlled.

Similarly, if the second power electronic switching tube 72 and the third power electronic switching tube 73 are turned on, and the first power electronic switching tube 71 and the fourth power electronic switching tube 74 are turned off, the current in the stator winding mechanism is in the reverse direction, that is, the current flows from the A second stator winding 141 to the A first stator winding 131, at this time, the direction of the force on the rotor is the positive direction of the X axis.

The principle of controlling the current direction of the B stator winding mechanism through the second full-bridge circuit composed of the fifth power electronic switch tube 75, the sixth power electronic switch tube 76, the seventh power electronic switch tube 77, and the eighth power electronic switch tube 78 is similar to the above description process, and is used to control the B stator winding mechanism, so that the force direction of the rotor 2 is the positive direction of the Y axis or the negative direction of the Y axis.

In order to control the position of the rotor 2 in real time, the first position sensor 4 collects the position information of the rotor 2 in real time and feeds it back to the current controller 81. The current controller 81 can be an analog circuit or a digital chip circuit that can run a program, such as a Microcontroller Unit (MCU), a Digital Signal Process (DSP), a Field Programmable Gate Array (FPAG), etc. the current controller 81 calculates the current command values of the two stator winding mechanisms in real time according to the position information of the rotor 2 in the X-Y plane, and calculates the turn-on and turn-off time of each power electronic switch tube in the two full-bridge circuits according to the current value measured by the current sensor 82, thereby the magnetic density of the air gap 6 in each direction of the rotor 2 is regulated, and the closed-loop control of the position of the rotor 2 in the X-Y plane is realized.

Further, the magnetic levitation system is further provided with a second position sensor 5, the second position sensor 5 and the first position sensor 4 are mounted in different positions, and the second position sensor 5 is also used to detect the position of the rotor 2 in the X-Y plane. For example, as shown in FIG. 10, the second position sensor 5 may be mounted in an area where the stator teeth 112 are close to the rotor 2, or the second position sensor 5 may be mounted in the gap between two adjacent stator teeth 112. Of course, when the number of the second position sensors 5 is multiple, the second position sensors 5 can be provided on the stator teeth 112 and between adjacent stator teeth 112. Since the mounting position of the second position sensor 5 is different from the mounting position of the first position sensor 4, the second position sensor 5 can receive different magnetic circuit information from the first position sensor 4.

When the second position sensor 5 is provided, the second position sensor 5 is also connected to the current controller 81.

During specific implementation, the magnetic coupling mechanism 3 can control the rotation of the rotor 2 around the Z axis by means of reluctance torque, electromagnetic torque, and the like.

In the magnetic coupling mechanism 3, the magnetic source 31 includes but is not limited to permanent magnets, coils and other materials or structures that can generate a magnetic field. The magnetic field generated by the magnetic source 31 attracts the magnetically permeable material structure 21 on the rotor 2, and generate interaction force with the rotor 2. When the magnetic coupling mechanism 3 rotates, the rotor 2 will also rotate with it, so that the rotation speed and position of the rotor 2 can be adjusted by controlling the rotation speed and position of the magnetic coupling mechanism 3.

When the magnetic source 31 is a coil, an alternating magnetic field can also be generated by controlling the phase and amplitude of the current in the coil, the combined magnetic field of the magnetic field generated by each magnetic source 31 is a rotating magnetic field vector, thereby attracting the rotor 2 to rotate. By controlling the rotation speed and position of the combined magnetic field vector, the rotation speed and position of the rotor 2 can be adjusted. It is worth noting that this control manner can drive the rotor 2 to rotate without the rotation of the magnetic coupling mechanism 3.

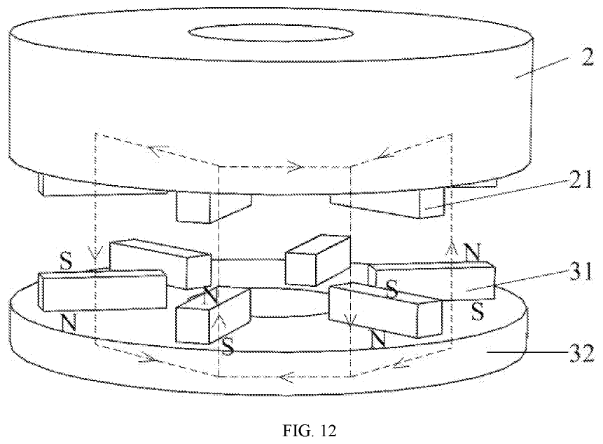

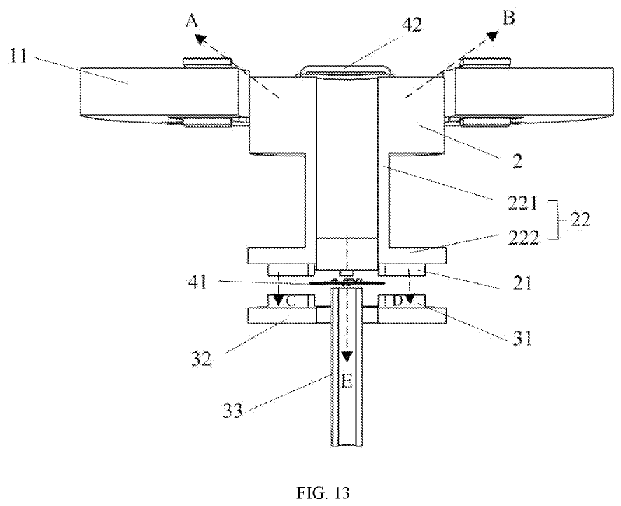

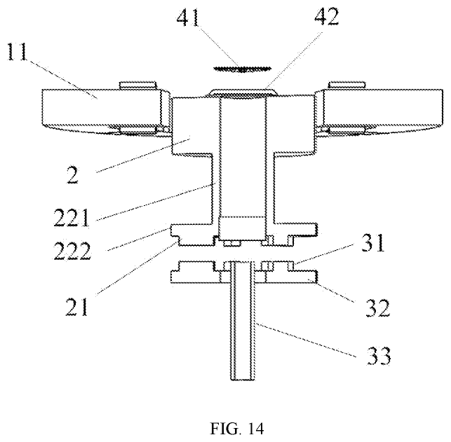

In the embodiment, the magnetically permeable material structure 21 can be directly mounted on the end surface of the rotor 2 facing the magnetic coupling mechanism 3 (as shown in FIGS. 11 and 12), or the rotor 2 can be connected to the magnetically permeable structure material 21 through the connecting frame 22 (as shown in FIGS. 13 and 14). For example, as shown in FIGS. 13 and 14, the connecting frame 22 includes a connecting post 221 and a mounting plate 222, and the mounting plate 222 is sleeved on the end of the connecting post 221. The connecting post 221 is connected to the side of the rotor 2 facing the magnetic coupling mechanism 3, and an end of the connecting post 221 facing the magnetic coupling mechanism 3 is provided with the mounting plate 222, and the magnetically permeable material structure 21 is mounted on the side of the mounting plate 222 facing the magnetic coupling mechanism 3.

Since the connecting frame 22 is added between the rotor 2 and the magnetically permeable material structure 21, the length of the whole of the rotor 2, the connecting frame 22 and the magnetically permeable material structure 21 along the Z axis direction is increased, so that the rotor force A and the rotor force B will produce greater torque relative to the center of the magnetic coupling mechanism 3 (that is, the torque around the X axis and Y axis), thereby the setting manner is more convenient to controlling the position of the rotor 2 on the X-Y plane, so that the rotor 2 is more stable during rotation.

The magnetic coupling mechanism 3 may include a support plate 32, a central shaft 33 and magnetic sources 31. The support plate 32 is sleeved on the central shaft 33, the support plate 32 is fixedly connected to the central shaft 33, and the magnetic sources 31 are mounted on the support plate 32. The support plate 32 provides a larger mounting space for the magnetic sources 31. Preferably, the central shaft 33 may be a hollow shaft body, and its inner cavity may be used for the data line and the power line of the stator portion 41 of the first position sensor 4 to pass through.

As shown in FIGS. 11 and 12, in the magnetic coupling mechanism 3, the number of magnetic sources 31 is multiple, and the multiple magnetic sources 31 are distributed at intervals along a circular track on a plane perpendicular to the axial direction of the stator. Preferably, the multiple magnetic sources are uniformly distributed on the circular track.

In a specific embodiment, the polarities of the magnetic sources 31 are the same, that is, the N poles of all the magnetic sources 31 are facing the rotor 2 (as shown in FIGS. 7, 8 and 11), or the S poles of all the magnetic sources 31 are facing the rotor 2.

When the stator portion 41 of the first position sensor 4 is arranged between the rotor 2 and the magnetic coupling mechanism 3, as shown in FIG. 7, the magnetic circuit starts from the magnetic source 31, then passes through the magnetically permeable material structure on the rotor 2, the rotor 2, the central area of the rotor, the stator portion 41, the central shaft 33, and the support plate 32 in turn, and flows back to the magnetic source 31 through the support plate 32 to form a magnetic circuit close loop. Due that all the magnetic fields generated by the magnetic coupling mechanism 3 in this arrangement pass through the first position sensor 4, thereby the first position sensor 4 can obtain the magnetic circuit information of the magnetic coupling mechanism 3.

When the stator portion 41 of the first position sensor 4 is arranged on the side of the rotor 2 away from the magnetic coupling mechanism 3, as shown in FIG. 8, the magnetic circuit starts from the magnetic source 31, then passes through the magnetically permeable material structure 21 on the rotor 2, the rotor 2, the central area of the rotor, the central shaft 33, and the support plate 32 in turn, and flows back to the magnetic source 31 through the support plate 32 to form a magnetic circuit close loop. In this arrangement, the magnetic circuit does not pass through the first position sensor 4, so that the first position sensor 4 can be prevented from being interfered by the magnetic field of the magnetic coupling mechanism 3.

In another specific embodiment, as shown in FIG. 12, the polarities of two adjacent magnetic sources 31 are opposite. That is to say, when the N pole of one magnetic source 31 faces the rotor 2, the magnetic sources 31 located on the adjacent two sides are all S poles facing the rotor 2. For the convenient of description, the magnetic source 31 with the N pole facing the rotor 2 is referred as the first magnetic source, and the magnetically permeable material structure 21 opposite to the first magnetic source is referred as the first magnetically permeable material structure. Further, the magnetic source 31 with the S pole facing the rotor 2 is referred as the second magnetic source, and the magnetically permeable material structure 21 opposite to the second magnetic source is referred as the second magnetically permeable material structure. The magnetic circuit starts from the first magnetic source, then passes through the first magnetically permeable material structure, the rotor 2, the second magnetically permeable material structure, the second magnetic source, and the support plate 32, and flows back to the first magnetic source through the support plate 32 to form a magnetic circuit close loop. This kind of magnetic circuit does not pass through the central area of the rotor 2, that is, does not pass through the first position sensor 4, so that the first position sensor 4 can be prevented from being interfered.

It is worth noting that, in addition to the above manners, other magnetic coupling manners can also be used to control the movement of the rotor 2 and are not limited to the above described magnetic coupling mechanism 3 and magnetic circuit setting manners.

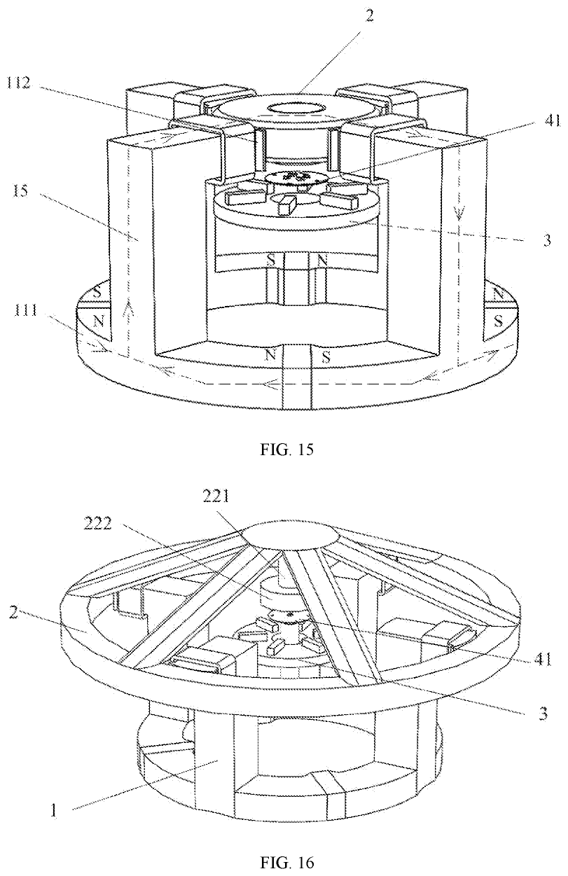

In this embodiment, the stator 1 is not limited to a ring structure, but may also be a temple-like structure (that is, the structural shape of the stator 1 is similar to that of the temple). As shown in FIG. 15, the stator core 11 includes a stator yoke 111, stator teeth 112 and stator supports 15. The stator teeth 112 are connected to the stator yoke 111 through the stator supports 15. Each stator support 15 includes a first section and a second section that are arranged relatively inclined and connected. One end of the first section is connected to the end surface of the stator yoke 111 and the other end is connected to the second section, and the second section extends toward the rotor 2. The stator teeth 112 are arranged at the end of the second section away from the first section. Due to the structure of the stator 1 composed of the stator core 11 with the above-mentioned structural shape is similar to a temple, it is called a temple structure.

In FIG. 15, the first section and the second section are vertically arranged.

When the stator 1 is configured as described above, the magnetic coupling mechanism 3 can extend into the area enclosed by the stator supports 15 to save space.

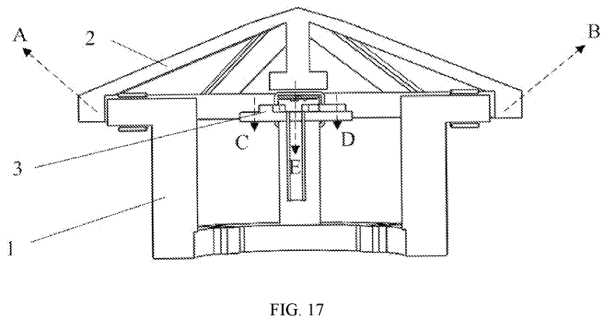

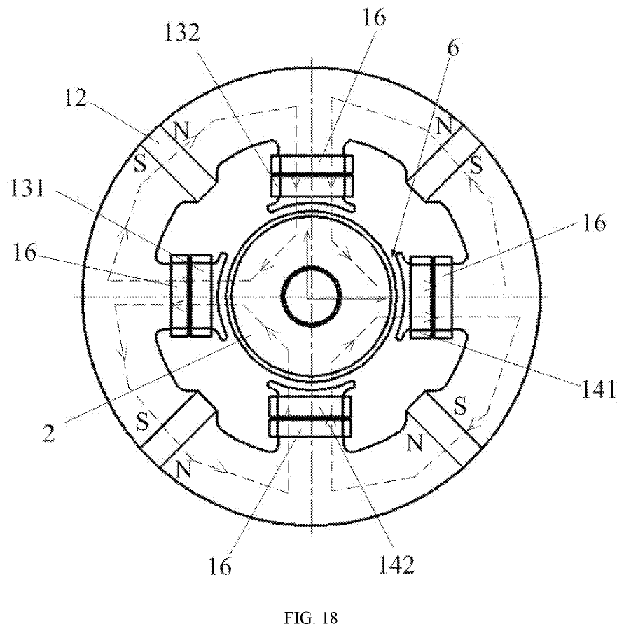

In the embodiment, the rotor 2 is not limited to a ring structure, but can also be an umbrella-like structure. As shown in FIGS. 16 and 17, the rotor 2 includes a ring portion and a rib portion, one end of the rib portion is connected to the ring portion, and the other end meets at one point and is connected to the connecting frame 22, and the connecting frame 22 is connected to the magnetically permeable material structure 21, so that the magnetically permeable material structure 21 is opposite to the magnetic coupling mechanism 3. In FIG. 16, the intersection of the rib portion is connected to the connecting post 221 of the connecting frame 22, the connecting post 221 is connected to the mounting plate 222, and the magnetically permeable material structure 21 is mounted on the mounting plate 222.

The magnetic levitation system provided by the embodiment has the following advantages: it realizes the decoupling of the rotating magnetic circuit control of the rotor 2 and the magnetic levitation magnetic circuit control, can be applied to a magnetic levitation motor, the control difficulty is lower, and the torque fluctuation is reduced. In addition, since the magnetic levitation system provided by the embodiment only needs to use a low-cost position sensor, there is no need to use an eddy current position sensor, so that the cost of the magnetic levitation system is reduced.

As shown in FIG. 18, in order to facilitate the control of the position of the rotor 2 in the Z axis direction, in a preferred embodiment, secondary windings 16 are also provided on the stator 1, and the magnetic field direction generated by each of the secondary windings 16 is the same as or opposite to the magnetic field direction generated by each of the stator permanent magnets 12.

When the magnetic field direction generated by the secondary winding 16 is the same as the magnetic field direction generated by the stator permanent magnet 12, the magnetic field of the air gap 6 between the rotor 2 and the stator 1 is strengthened, so that the force on the rotor 2 in the positive direction of the Z axis is increased. Since the interaction between the magnetic coupling mechanism 3 and the rotor 2 causes the rotor 2 to suffer the same force along the negative direction of the Z axis, thereby increasing the force of the rotor 2 along the positive direction of the Z axis will cause the rotor 2 trend to move toward the positive direction of the Z axis, and finally, the rotor 2 moves to a new levitation position along the Z axis.

When the magnetic field direction generated by the secondary winding 16 is opposite to the magnetic field direction generated by the stator permanent magnet 12, the magnetic field of the air gap 6 between the rotor 2 and the stator 1 is weakened, so that the force of the rotor 2 in the positive direction of the Z axis is reduced. Since the interaction between the magnetic coupling mechanism 3 and the rotor 2 causes the rotor 2 to suffer the same force in the negative direction of the Z axis, thereby reducing the force of the rotor 2 along the positive direction of the Z axis will cause the rotor 2 trend to move toward the negative direction of the Z axis, and finally, the rotor 2 moves to a new levitation position along the Z axis.

It can be seen from the above that by adjusting the current in the secondary winding 16, the position of the rotor in the Z-axis direction can be adjusted.

In a specific embodiment, as shown in FIG. 18, the secondary winding 16 may be sleeved on the stator teeth 112. Of course, in other embodiments, the secondary winding 16 can also be arranged in other positions of the stator, for example, sleeved on the stator yoke 111. The number of secondary windings 16 is multiple, and at least one secondary winding 16 is provided between two adjacent stator permanent magnets 12. The multiple secondary windings 16 are evenly distributed on the stator.

The above are only optional embodiments of the present application and are not intended to limit the present application. Any modification, equivalent replacement and improvement made within the spirit and principle of the present application shall be included within the protection of the present application.

1. A magnetic levitation system, comprising:
a stator, comprising stator cores, stator permanent magnets, and a stator winding mechanism, wherein each stator permanent magnet and the stator winding mechanism are both arranged at the stator core;
a rotor, providing with a magnetically permeable material structure, wherein the stator winding mechanism is configured for controlling the rotor to move away from or close to an axis direction of the stator;
a magnetic coupling mechanism, comprising magnetic sources capable of being magnetically attracted to the magnetically permeable material structure, wherein the magnetic coupling mechanism is configured for magnetically coupling with the rotor to drive the rotor to rotate around the axis direction of the stator.

2. The magnetic levitation system of claim 1, wherein a number of the magnetic sources is multiple, and the multiple magnetic sources are distributed at intervals along a circular track on a plane perpendicular to the axial direction of the stator; polarities of the magnetic sources are the same, or polarities of two adjacent magnetic sources are opposite.

3. The magnetic levitation system of claim 1, wherein the stator is further provided with secondary windings, and a magnetic field direction generated by each of the secondary windings is the same as or opposite to a magnetic field direction generated by each of the stator permanent magnets.

4. The magnetic levitation system of claim 1, wherein the magnetic levitation system further comprises a connecting frame, the magnetically permeable material structure is arranged onto the rotor through the connecting frame, and the connecting frame is located between the magnetic coupling mechanism and the rotor.

5. The magnetic levitation system of claim 1, wherein the magnetic levitation system further comprises a first position sensor, and the first position sensor is configured for detecting a position of the rotor on a planer perpendicular to the axial direction of the stator, the first position sensor comprises a stator portion and a rotor portion, the stator portion is connected to the stator, the rotor portion is connected to the rotor, and the stator portion and the rotor portion are arranged coaxially.

6. The magnetic levitation system of claim 1, wherein at least part of a structure of the rotor portion is made of a magnetically permeable material, or the magnetic coupling mechanism is provided with a rotor permanent magnet.

7. The magnetic levitation system of claim 1, wherein each of the stator cores is provided with an arc-shaped stator yoke and stator teeth extending in a direction close to the rotor, and the stator winding mechanism is arranged at the stator yoke and/or the stator teeth;
the magnetic levitation system further comprises a second position sensor mounted on the stator teeth or between two adjacent stator teeth.

8. The magnetic levitation system of claim 1, wherein a number of the stator winding mechanism is at least two, and each stator winding mechanism comprises first stator windings and second stator windings, and the first stator windings and the second stator windings are arranged symmetrically with respect to the axis direction of the stator.

9. The magnetic levitation system of claim 8, wherein the magnetic levitation system further comprises a winding drive mechanism comprising a full-bridge circuit; in the stator winding mechanism, the first stator windings and the second stator windings are respectively connected to corresponding full-bridge circuit, and dotted terminals of the first stator windings are connected to dotted terminals of the second stator windings.

10. The magnetic levitation system of claim 8, wherein in the stator winding mechanism, a number of the first stator winding is multiple, and the multiple first stator windings are connected in series;
and/or, a number of the second stator winding is multiple, and the multiple second stator winding are connected in series.
